(19) United States
(12) Patent Application Publication
(10) Pub. No.: US 2025/0136080 A1
(43) Pub. Date: May 1, 2025

(54) SYSTEM AND METHOD FOR PROVIDING LAUNCH CONTROL MODE ON BATTERY ELECTRIC VEHICLE

(71) Applicant: FCA US LLC, Auburn Hills, MI (US)

(72) Inventors: Paul E. Rodriguez, White Lake, MI (US); Jeremy J. Anker, Lake Orion, MI (US); Sean King, Macomb Twp, MI (US); Dean Baker, Rochester Hills, MI (US); Jon Strunk, Rochester Hills, MI (US); Allison Singer, Oxford, MI (US); Jason Trombley, Imlay City, MI (US); David Carr, Brighton, MI (US); Haley Lee, Rochester Hills, MI (US); Kanishk Bakshi, Farmington Hills, MI (US); Mark Platt, Van Buren Twp, MI (US); Brian Driscoll, New Hudson, MI (US); Joe Nissen, Auburn Hills, MI (US)

(21) Appl. No.: 18/499,361

(22) Filed: Nov. 1, 2023

(51) Int. Cl. B60W 10/08; B60W 10/18; B60W 10/26; B60W 50/14

(52) U.S. Cl. CPC B60W 10/08; B60W 10/18; B60W 10/26; B60W 50/14; B60W 2510/244; B60W 2720/26

(57) ABSTRACT

A vehicle system for a vehicle that implements a launch control mode to vehicle wheels for creating a launch control includes a motor, an instrument panel and a controller. The motor provides drive torque to at least one wheel of the vehicle wheels for propelling the vehicle. The instrument panel cluster is configured to display a user interface menu that includes a user selectable launch control mode. The controller initiates a launch control mode based on user selection of the launch control mode. The controller determines whether vehicle conditions are satisfied and receives a launch intensity selected at the user interface menu. The controller enables torque to be delivered from the motor to all drive wheels based on the launch intensity. Wheel speeds are monitored and wheel slip is determined. Torque is sent to select wheels based on the determined wheel slip.

### FIELD

The present disclosure relates generally to a system and method for providing a launch control mode on a battery electric vehicle.

### BACKGROUND

Vehicle launch control is a vehicle maneuver where optimal straight-line acceleration is provided from a stationary start. Typically, a traction control system prevents the spinning of any wheel or axle by reducing the torque required to spin one wheel more than another wheel. On vehicles with electric motors, an instant torque is provided from zero engine speed. As a result, it can be difficult to set an engine speed to control the amount of torque. In this regard, while a launch control event can be accomplished when purposefully intended by an experienced driver, there remains a need for improvement in the relevant art.

### SUMMARY

In one example aspect of the invention, a vehicle system for a vehicle that implements a launch control mode to vehicle wheels for creating a launch control includes a motor, an instrument panel and a controller. The motor provides drive torque to at least one wheel of the vehicle wheels for propelling the vehicle. The vehicle wheels include a left and right rear wheels and left and right front wheels. The instrument panel cluster is configured to display a user interface menu that includes a user selectable launch control mode. The controller initiates a launch control mode based on user selection of the launch control mode. The controller determines whether vehicle conditions are satisfied and receives a launch intensity selected at the user interface menu. The controller enables torque to be delivered from the motor to all drive wheels based on the launch intensity. Wheel speeds are monitored and wheel slip is determined. Torque is sent to at least one of the left and right rear wheels and left and right front wheels based on the determined wheel slip.

In another aspect, the vehicle conditions include a battery system that powers the motor having a charge above a charge threshold. In examples, the charge threshold is 20%.

In some implementations, the vehicle conditions include a steering wheel input indicative of a straight direction.

In some configurations, the vehicle system further comprises a grade sensor that communicates a grade signal to the controller indicative of a grade the vehicle occupies. The vehicle conditions include a grade of zero.

According to additional examples, the vehicle system further comprises wheel speed sensors at each of the vehicle wheels that communicate wheel speed signals to the controller. The vehicle conditions include wheels speeds from the respective wheel speed sensors of zero.

In additional implementations, the vehicle system further comprises a park brake that communicates a park brake signal to the controller. The vehicle conditions include a park brake signal indicative of the park brake being not engaged.

In examples, the user interface menu includes a wheel slip meter that displays a wheel slip of the left and right rear wheels and the left and right front wheels.

A method for implementing a launch control mode to vehicle wheels for creating a launch control on an electrified vehicle having an electric motor is provided. In one example implementation, a launch intensity is received. A determination is made whether the launch control mode has been activated. A determination is made whether vehicle conditions are satisfied. Based on the vehicle conditions being satisfied, torque is enabled to be delivered from the electric motor to drive wheels of the vehicle wheels based on the launch intensity. Wheel speeds are monitored and wheel slip is determined. Torque is sent to at least one of the left and right rear wheels and left and right front wheels based on the determined wheel slip.

In examples, determining whether the launch control mode has been activated comprises displaying, at an instrument panel cluster, a user interface menu that includes a user selectable launch control mode; and receiving a signal indicative of a user selecting the user selectable launch control mode.

In examples, determining whether vehicle conditions are satisfied comprises determining whether a battery system that powers the motor has a charge above a charge threshold. In some examples, the charge threshold is 20%.

In other examples, determining whether vehicle conditions are satisfied comprises receiving a steering wheel signal from the steering wheels; and determining that the steering wheel signal is indicative of a straight direction.

In other examples, determining whether vehicle conditions are satisfied comprises receiving a grade signal from a grade sensor; and determining that the grade sensor signal is indicative of a level ground.

In other examples, determining whether vehicle conditions are satisfied comprises receiving speed signals from wheel speed sensors at the left and right front wheels and the left and right rear wheels; and determining that the speed signals are indicative of zero speed.

In other examples, determining whether vehicle conditions are satisfied comprise receiving a park brake signal from a park brake; and determining that the park brake signal is indicative of the park brake not being engaged.

In additional examples, the method includes displaying at a user interface menu a wheel slip meter that displays a wheel slip of the left and right rear wheels and the left and right front wheels.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic block diagram of an exemplary vehicle system according to the principles of the present disclosure;

FIGS. 2A-2D are exemplary menu interfaces provided on the instrument panel cluster of the vehicle system of FIG. 1 for entering launch control mode according to the principles of the present disclosure; and

FIG. 3 is an example functional block diagram of a launch control mode implemented by the exemplary controller of FIG. 1 according to the principles of the present disclosure.

### DESCRIPTION

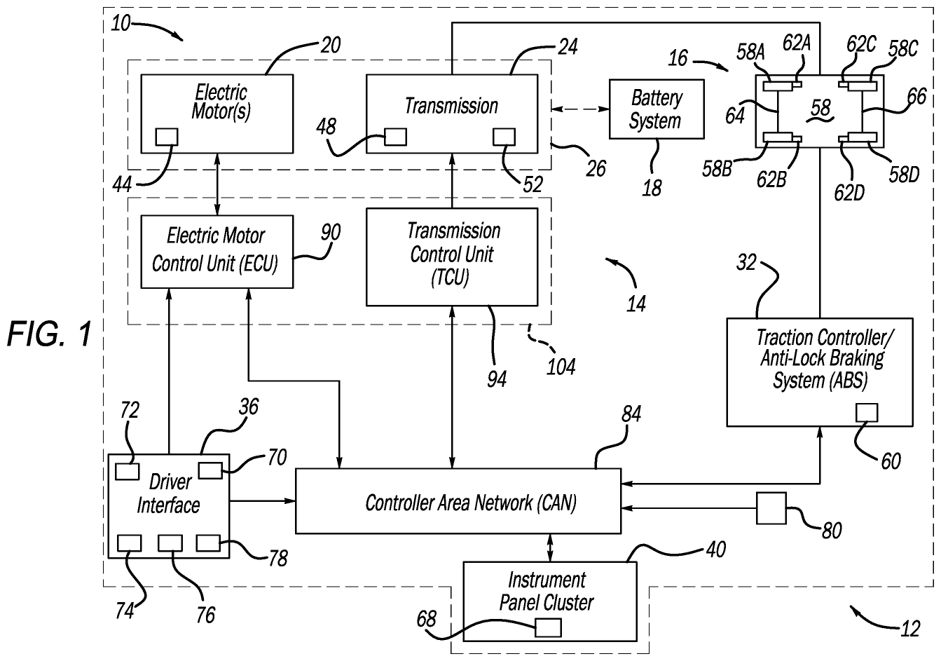

With initial reference to FIG. 1, an exemplary vehicle system is schematically shown and generally identified at reference numeral 10. In accordance with various aspects of the present disclosure, interactive techniques, referred to herein as a “launch control mode” for permitting an exemplary vehicle 14 to perform a launch control event are implemented utilizing the vehicle system 10. As will be discussed in greater detail below, in one example implementation the interactive launch control mode is initiated upon a vehicle driver selecting a launch control mode from an interactive menu displayed on an instrument cluster of the vehicle system. The launch control mode can only be entered based on satisfying a number of vehicle conditions. In some prior art launch control systems, the system is calibrated in a continuous feedback loop based on an engine speed that the customer selects. However, as the customer changes tires, track surfaces change, ambient temperatures change, or engine speed changes, the system becomes less effective.

With continuing reference to FIG. 1, the exemplary vehicle system 10 is associated with an exemplary electrified vehicle 12 and includes an electrified powertrain 14 configured to transfer drive torque to a driveline 16 of the vehicle 14 for propulsion. The electrified powertrain 14 generally comprises a high voltage battery system 18, one or more electric motors 20, and a transmission 24. The one or more electric motors 20 and the transmission 24 can be collectively referred to herein as an electric drive module 26. While the exemplary implementation includes a transmission 24, in some examples the electrified powertrain 14 does not include a transmission.

The vehicle system 10 further includes a traction controller and/or an anti-lock brake system (ABS) 32. While shown together it will be appreciated that the vehicle system can have a dedicated traction control system that operates independent of an anti-lock brake system. The vehicle system 10 further includes a driver interface 36 and an instrument panel or cluster 40. The instrument panel or cluster 40 can include any interface device, such as a driver information center and/or vehicle infotainment system capable of receiving input from a driver.

The electric motor 20 includes an engine speed sensor 44. The transmission 24 includes various transmission speed sensors, such as input and output transmission shaft speed sensors 48 and various shift sensors 52, to provide a signal to an associated control system indicative of a transmission gear selected. The transmission 24 and traction controller 32 are coupled or selectively coupled, directly or indirectly, to one or more wheels 58 of vehicle 12, as is known in the art. In the exemplary vehicle system, all of the wheels 58 are drive wheels that receive torque input. While the motor 20 is described herein as an electric motor, in other examples, the vehicle system 10 can be configured with a conventional internal combustion engine (ICE), or a hybrid electric vehicle.

The wheels 58 are identified individually as front wheels 58A, 58B and rear wheels 58C, 58D. The wheels 58A, 58B, 58C and 58D each have wheel speed sensors 62A, 62B, 62C and 62D. In the example shown, the front wheels 58A and 58B are selectively coupled by a front axle 64. Similarly, the rear wheels 58C and 58D are selectively coupled by a rear axle 66. In the exemplary implementation illustrated, the traction controller 32 is controlled to activate foundation brakes 60.

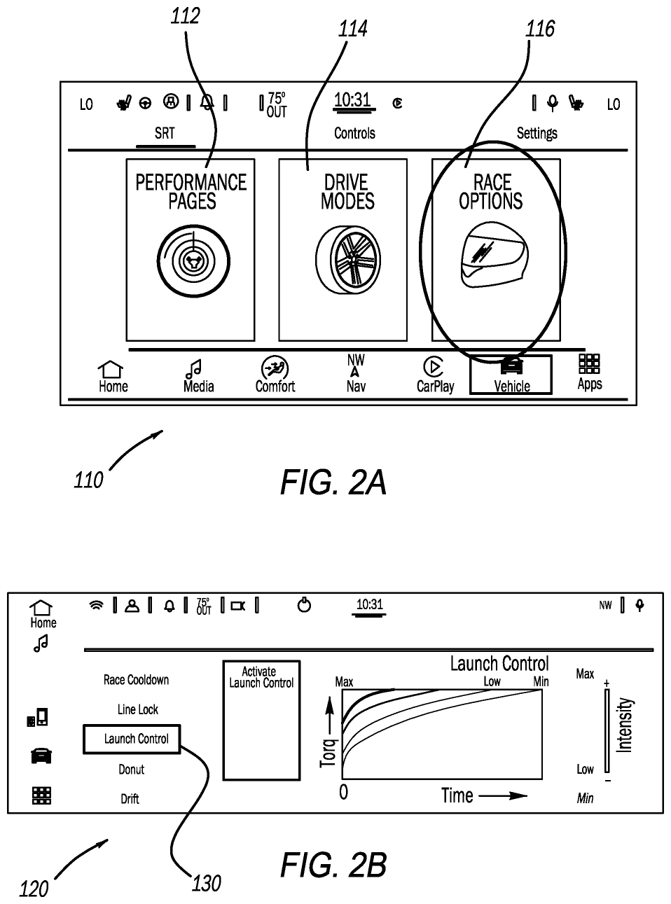

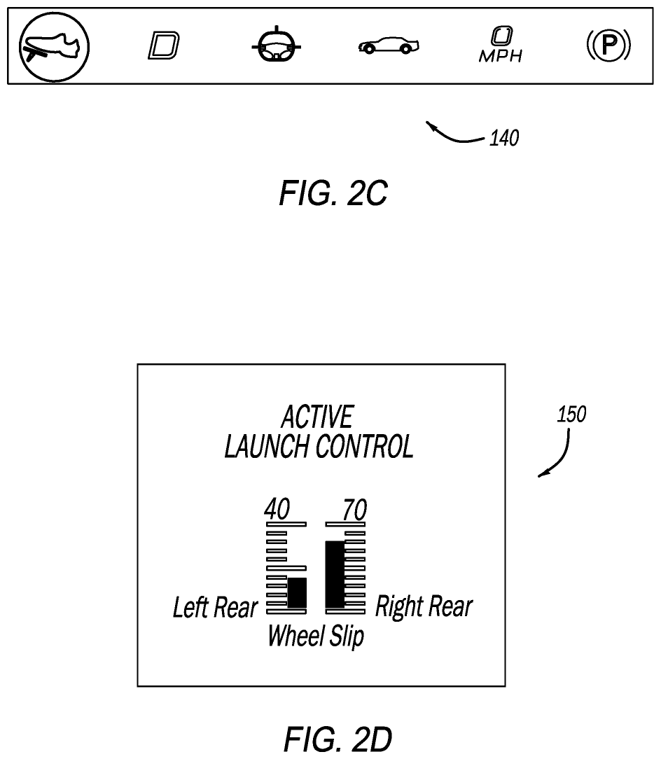

The instrument panel cluster 40 includes various indicators, such as a launch control mode activate light or indicator 68. As will be described herein with respect to FIGS. 2A-2D, the instrument panel cluster 40 provides a menu driven sequence to the driver to enable launch control mode. The driver interface 36 includes a steering wheel 70 and a brake pedal 72. The driver interface 36 includes a driver input device, e.g., an accelerator pedal 74, for providing a driver input, e.g., a torque request, for the motor 20. The driver interface 36 can further include a park brake 76. The driver interface 36 or vehicle interior also includes a transmission shift request device, such as a shift lever or rotary shifter 78, for the driver to request a desired gear of the transmission 24. The shift lever or rotary shifter 78 can provide conventional transmission options including park, reverse, neutral, drive and low. The vehicle system 10 also includes sensors 80. The sensors 80 can include longitudinal sensor or other equivalent sensor for providing data indicative of whether or not the vehicle 12 is on a grade and the incline or angle of the grade.

One or more controllers are utilized to control the various vehicle components or system discussed above. In one exemplary implementation, various individual controllers are utilized to control the various components/systems discussed herein and are in communication with each other and/or the various components/systems via a local interface 84. In this exemplary implementation, the local interface 84 is one or more buses or other wired or wireless connections, as is known in the art. In the example illustrated in FIG. 1, the local interface 84 is a controller area network (CAN). The CAN 84 may include additional elements or features, which have been omitted for simplicity, such as controllers, buffers (cache) drivers, repeaters and receivers, among many others, to enable communications. Further, the CAN 84 may include address, control and/or data connections to enable appropriate communications among the components/systems described herein.

In the example illustrated in FIG. 1, the vehicle system 10 includes an electric motor control unit (ECU) 90 for controlling the motor 20, and a transmission control unit (TCU) 94 for controlling the transmission 24. Both of the control units 90 and 94 as well as the traction controller 32, driver interface 36, instrument cluster 40 and sensor 80 are in communication with CAN 84 and thus each other. Again, in some examples a transmission 24 and therefore the TCU 94 is not included. It will be appreciated that while individual control units are discussed herein and shown in various Figures, the individual control units may also be optionally implemented in the form of one control unit, such as a powertrain or vehicle control unit, represented by broken line 104 in FIG. 1. Thus, it will be appreciated that while the discussion will continue with reference to the individual controllers discussed above, the discussion is equally applicable to the components of vehicle system 10 being controlled by one controller.

Referring now to FIGS. 2A-2D and with reference back to FIG. 1, an example menu sequence provided to the vehicle driver at the instrument panel cluster 40 will be described. At FIG. 2A, a first menu 110 displays performance pages 112, drive modes 114 and race options 116. As a result of a driver selecting race options 116 at the first menu 110, a second menu 120 (FIG. 2B) is displayed at the instrument panel cluster 40. The second menu 120 can include various modes including a launch control mode 130. As a result of the driver selecting the launch control mode 130 at the second menu 120, a third menu 140 (FIG. 2C) is displayed at the instrument panel cluster 40. The third menu 140 can include instructions to the driver with vehicle conditions that must be satisfied for entering launch control mode.

Exemplary instructions include a state of charge of the battery system 18 must be above a threshold (such as 20%). The brake pedal 72 must be applied. The shift lever or rotary shifter 78 must be in drive. The steering wheel 70 must be straight. The speed of the vehicle 12 mush be zero. The vehicle 12 must be on level ground (such as based on an input from the sensor 80). The park brake 76 must not be engaged. With all vehicle conditions being satisfied at the third menu 140, a fourth menu 150 (FIG. 2D) is displayed at the instrument panel cluster 40. In examples, the fourth menu 150 can comprise a wheel slip graphic or meter that displays wheel slip (e.g., such as for the rear wheels 58C and 58D). It is appreciated that the menus 110, 120, 140 and 150 illustrated are merely exemplary and may take many different forms. It is further contemplated that some of the menus (or an additional menu) can be additionally configured to instruct the vehicle driver on how to initiate launch control where optimal straight-line acceleration is provided from a stationary start.

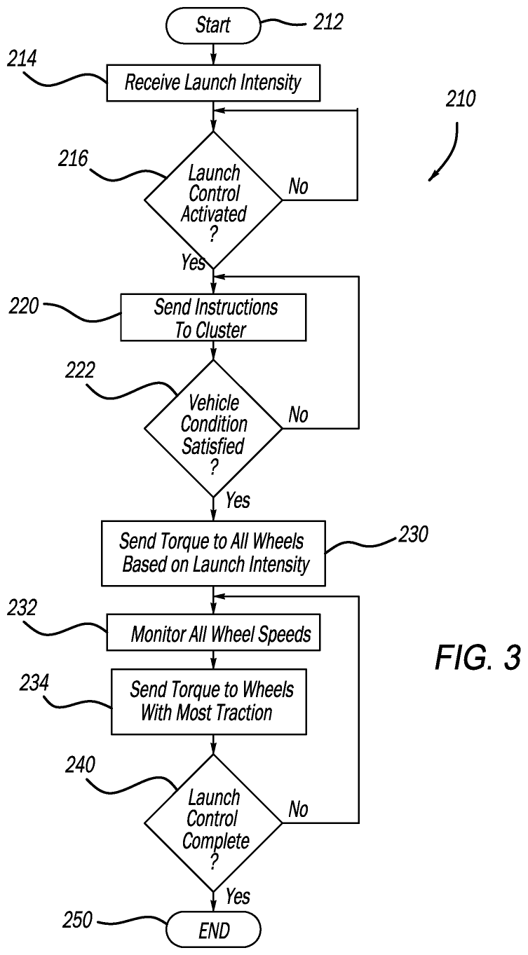

Accordingly, systems and methods or techniques are provided for implementing the launch control mode using the vehicle system 10. One example implementation of such launch control mode technique is discussed below in connection with the exemplary flowchart 210 shown in FIG. 3.

With particular reference to FIG. 2, the exemplary methodology 210 for operating a launch control mode in the vehicle system 10 will be described. The method 210 starts at 212. At 214 control receives a launch intensity selected by the user at the user interface menus (FIGS. 2A-2D). Control determines whether the launch control mode has been activated/initiated at 216. Again, the launch control mode can be initiated such as by selection of the launch control mode at menu 120 (FIG. 2B) on the drive interface 36 (see FIG. 1). If the launch control mode has not been initiated, control loops to 216. If launch control mode has been initiated at 216, control identifies the instructions to the vehicle driver with vehicle requirements that must be satisfied to proceed with launch control mode. In examples, at least one of the controllers 32, 90, 94 can determine whether the vehicle conditions are satisfied. If the vehicle requirements have not been satisfied at 222, control loops to 220. It is contemplated that the instrument cluster 40 can alert or highlight to the driver which condition or conditions are not yet satisfied such that the driver can perform corrective actions to satisfy the identified requirements.

If the vehicle requirements have been satisfied at 222, At 230, control sends torque to all drive wheels 58A, 58B, 58C and 58D at 226 based on the launch intensity selected. At 232 control monitors wheel speeds of the wheels 58A, 58B, 58C and 58D. In examples, at 232 the controller 32 can also receive wheel speeds from the respective wheel speed sensors 62A, 62B, 62C and 62D and determine wheel slip of the wheels 58A, 58B, 58C, 58D based on a comparison of the wheel speeds. At 234 control sends torque to the wheel(s) 58A, 58B, 58C, 58D with the most traction. The wheel 58A, 58B, 58C, 58D with the most traction can be identified as the wheel(s) with the least amount of wheel slip. At 240 control determines whether launch control 240 is complete. In examples, launch control can end based on an input from the driver at the menus (FIGS. 2A-2D). Control ends at 250.

It will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A vehicle system for an electrified vehicle that implements a launch control mode to vehicle wheels for creating a launch control, the vehicle system comprising:
a motor that provides drive torque to at least one wheel of the vehicle wheels for propelling the vehicle, the vehicle wheels including left and right rear wheels and left and right front wheels;
an instrument panel cluster configured to display a user interface menu that includes a user selectable launch control mode; and
a controller that initiates the launch control mode based on user selection of the launch control mode, wherein the controller:
determines whether vehicle conditions are satisfied;
receives launch intensity selected at the user interface menu;
enables, based on the vehicle conditions being satisfied, torque to be delivered from the motor to all drive wheels of the vehicle wheels based on the launch intensity;
monitors wheel speeds of the left and right rear wheels and left and right front wheels;
determines wheel slip of the left and right rear wheels and left and right front wheels; and
sends drive torque to at least one of the left and right rear wheels and left and right front wheels based on the determined wheel slip.

2. The vehicle system of claim 1, wherein the vehicle conditions include a battery system that powers the motor having a charge above a charge threshold.

3. The vehicle system of claim 2, wherein the charge threshold is 20%.

4. The vehicle system of claim 1, wherein the vehicle conditions include a steering wheel input indicative of a straight direction.

5. The vehicle system of claim 1, further comprising a grade sensor that communicates a grade signal to the controller indicative of a grade the vehicle occupies, wherein the vehicle conditions include a grade of zero.

6. The vehicle system of claim 1, further comprising wheel speed sensors at each of the vehicle wheels that communicate wheel speed signals to the controller, wherein the vehicle conditions include wheel speeds from the respective wheel speed sensors of zero.

7. The vehicle system of claim 1, further comprising a park brake that communicates a park brake signal to the controller, wherein the vehicle conditions include a park brake signal indicative of the park brake being not engaged.

8. The vehicle system of claim 1, wherein the user interface menu that includes a wheel slip meter that displays a wheel slip graphic of the left and right rear wheels and the left and right front wheels.

9. A method for implementing a launch control mode to vehicle wheels for creating a launch control on an electrified vehicle having an electric motor, the method comprising:
receiving a launch intensity;
determining whether a launch control mode has been activated;
determining whether vehicle conditions are satisfied;
enabling, based on the vehicle conditions being satisfied, torque to be delivered from the electric motor to all drive wheels of the vehicle wheels based on the launch intensity;
monitoring wheel speeds of the left and right rear wheels and the left and right front wheels of the vehicle wheels;
determining wheel slip of the left and right rear wheels and left and right front wheels; and
sending drive torque to at least one of the left and right rear wheels and left and right front wheels based on the determined wheel slip.

10. The method of claim 9, wherein determining whether the launch control mode has been activated comprises:
displaying, at an instrument panel cluster, a user interface menu that includes a user selectable launch control mode; and
receiving a signal indicative of a user selecting the user selectable launch control mode.

11. The method of claim 9, wherein determining whether vehicle conditions are satisfied comprises:
determining whether a battery system that powers the motor has a charge above a charge threshold.

12. The method of claim 11, wherein the charge threshold is 20%.

13. The method of claim 9, wherein determining whether vehicle conditions are satisfied comprises:
receiving a steering wheel signal from a steering wheel; and
determining that the steering wheel signal is indicative of a straight direction.

14. The method of claim 9, wherein determining whether vehicle conditions are satisfied comprises:
receiving a grade signal from a grade sensor indicative of a grade the vehicle occupies; and
determining that the grade signal is indicative of a level ground.

15. The method of claim 9, wherein determining whether vehicle conditions are satisfied comprises:
receiving speed signals from wheel speed sensors at the left and right front wheels and the left and right rear wheels; and
determining that the speed signals are indicative of a zero speed.

16. The method of claim 9, wherein determining whether vehicle conditions are satisfied comprises:
receiving a park brake signal from a park brake; and
determining that the park brake signal is indicative of the park brake not being engaged.

17. The method of claim 9, further comprising:
displaying at a user interface menu a wheel slip meter that displays a wheel slip graphic for the left and right rear wheel and the left and right rear front wheel.
